(19) United States
(12) Patent Application Publication
(10) Pub. No.: US 2025/0082096 A1
(43) Pub. Date: Mar. 13, 2025

(54) Broom Cleaning Apparatus & Method for Cleaning a Concrete Finishing Broom

(71) Applicant: Steven Yuslum, Williamstown, PA (US)

(72) Inventor: Steven Yuslum, Williamstown, PA (US)

(21) Appl. No.: 18/367,817

(22) Filed: Sep. 13, 2023

(51) Int. Cl. A46B 17/06; B08B 1/00; B08B 1/02; B08B 3/04

(52) U.S. Cl. CPC A46B 17/06; B08B 1/165; B08B 1/20; B08B 3/04; A46B 2200/40

(57) ABSTRACT

A broom cleaning apparatus for cleaning a concrete finishing broom includes a trough defining a reservoir in the trough for containing a fluid. The trough has a rim defining an opening to the reservoir at a top side of the trough. The opening is elongated and has a size such that the opening is configured for receiving a brush of the concrete finishing broom. A wiper is coupled to the rim of the trough and extends inwardly with respect to the rim.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to broom cleaning apparatus and more particularly pertains to a new broom cleaning apparatus for cleaning a concrete finishing broom.

### (2) Description of Related Art Including Information Disclosed Under 37 CFR 1.97 and 1.98

Myriad tools and methods are generally known for cleaning broom brushes. But the prior art fails to disclose an apparatus which comprises a trough with a wiper lining a rim of the trough for wetting a brush of a concrete finishing broom with fluid contained in the trough and wiping aggregate from the brush with the wiper.

### BRIEF SUMMARY OF THE INVENTION

An embodiment of the disclosure meets the needs presented above by generally comprising a trough defining a reservoir in the trough for containing a fluid. The trough has a rim defining an opening to the reservoir at a top side of the trough. The opening is elongated and has a size such that the opening is configured for receiving a brush of a concrete finishing broom. A wiper is coupled to the rim of the trough and extends inwardly with respect to the rim.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a broom cleaning apparatus according to an embodiment of the disclosure.

FIG. 2 is a top view of an embodiment of the disclosure.

FIG. 3 is a rear view of an embodiment of the disclosure.

FIG. 4 is a side view of an embodiment of the disclosure.

FIG. 5 is a cross-section view of an embodiment of the disclosure taken from Arrows 5-5 in FIG. 3.

FIG. 6 is a cross-section in-use view of an embodiment of the disclosure, taken from Arrows 6-6 in FIG. 3.

FIG. 7 is an in-use view of an embodiment of the disclosure.

### DETAILED DESCRIPTION OF THE INVENTION

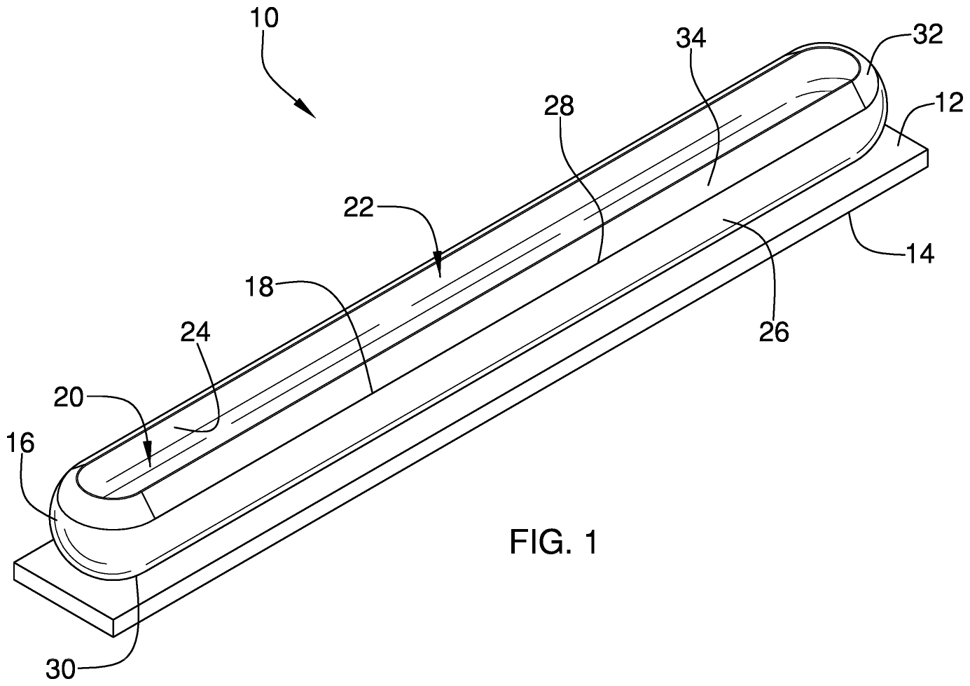

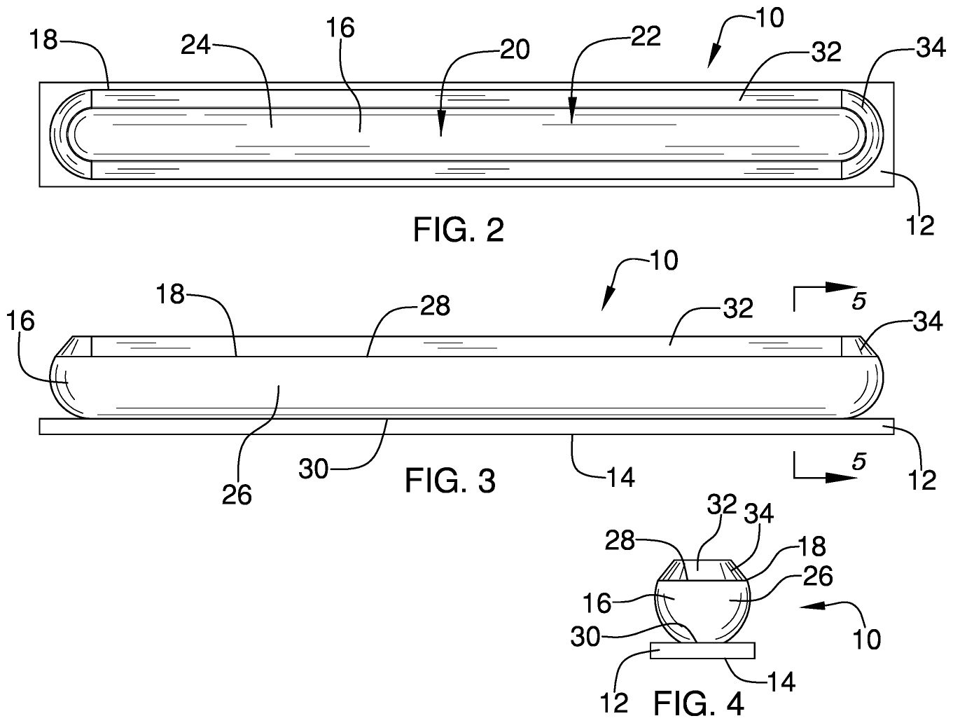

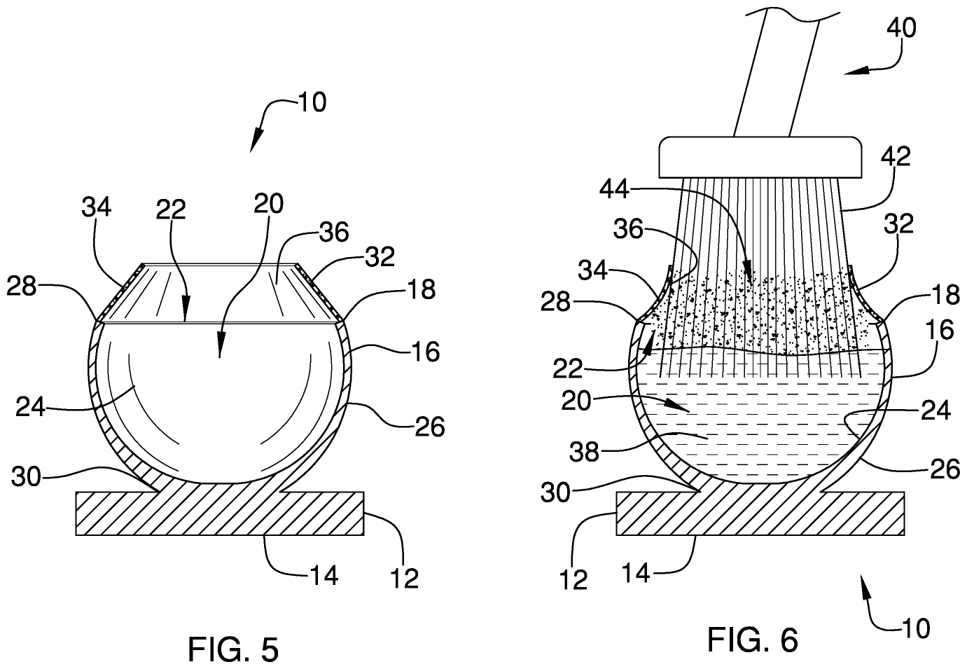

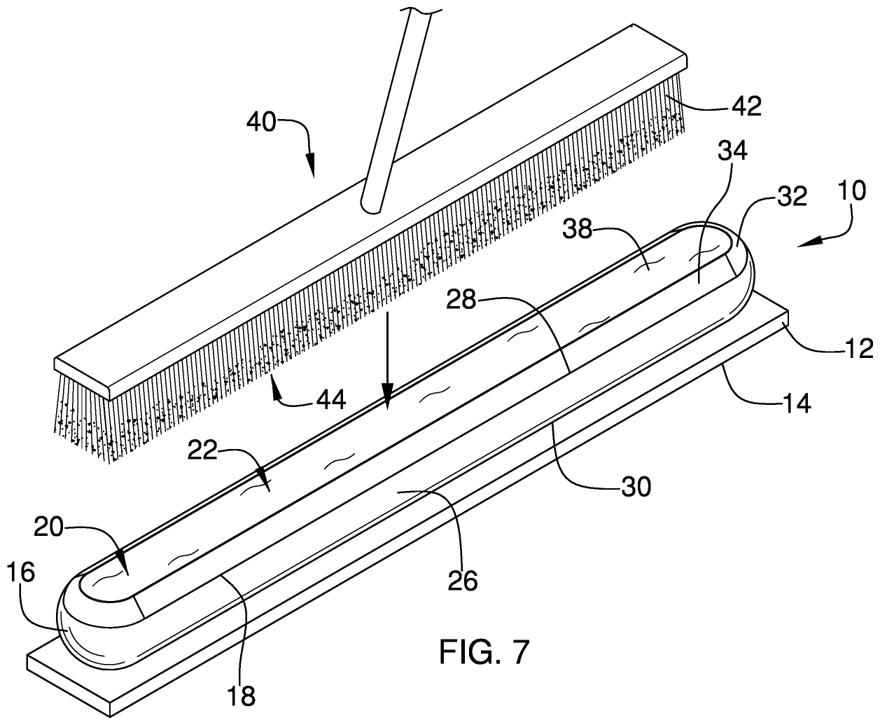

With reference now to the drawings, and in particular to FIGS. 1 through 7 thereof, a new broom cleaning apparatus embodying the principles and concepts of an embodiment of the disclosure and generally designated by the reference numeral 10 will be described.

As best illustrated in FIGS. 1 through 7, the broom cleaning apparatus 10 generally comprises a base 12 with a planar bottom 14 such that the base 12 is configured for being positioned on a planar support surface (not shown). A trough 16 is mounted on the base 12 and defines a reservoir 20 in the trough 16 for containing a fluid 38. The trough 16 has a rim 18 defining an opening 22 to the reservoir 20 at a top side 28 of the trough 16. The opening 22 is elongated and has a size such that the opening 22 is configured for receiving a brush 42 of a concrete finishing broom 40. An interior surface 24 of the trough 16 is continuously arcuate and extends around a longitudinal axis of the reservoir 20. A thickness of the trough 16 between the interior surface 24 and an exterior surface 26 of the trough 16 tapers from a bottom side 30 of the trough 16 to the rim 18.

A wiper 32 is coupled to the rim 18 of the trough 16 and extends inwardly with respect to the rim 18. The wiper 32 comprises a resiliently bendable material such that the wiper 32 is configured to bend when the brush 42 of the concrete finishing broom 40 is urged against the wiper 32 while moving through the opening 22 of the reservoir 20. The resiliently bendable material comprises rubber but may comprise silicone, another polymer, or the like. In some embodiments, the wiper 32 may be rigid, but it is noted that the resiliently bendable material facilitates wiping of the brush 42 while reducing a likelihood of damage to the brush 42. Also, the resiliently bendable material permits brushes with different widths to be wiped by the wiper 32, because the wiper 32 may be made to bend further to accommodate larger brushes. The wiper 32 extends along an entirety of the rim 18. An outer surface 34 of the wiper 32 is flush with the exterior surface 26 of the trough 16, and an inner surface 36 of the wiper 32 is inset from the rim 18 of the trough 16.

Another embodiment of the disclosure includes a method of cleaning a concrete finishing broom 40 which also describes a use of the broom cleaning apparatus 10. The method comprises adding a fluid 38 to a reservoir 20 of a trough 16 of the broom cleaning apparatus 10. The fluid 38 is water but also may be a cleaning solution or the like. A brush 42 of the concrete finishing broom 40 is inserted through an opening 22 of the reservoir 20 and into the fluid 38, thereby wetting the brush 42. The fluid 38 mixes with aggregate particles 44 and other debris found on the brush 42 and facilitates removal of the aggregate particles 44 and other debris from the brush 42. The brush 42 is wiped against a wiper 32 of the broom cleaning apparatus 10 to free the aggregate particulates from the brush 42. The wiper 32 is coupled to a rim 18 of the trough 16 around the opening 22 of the reservoir 20. The aggregate particles 44 are collected in the reservoir 20 and may be disposed from the reservoir 20 by dumping from the broom cleaning apparatus 10, vacuuming, or other suitable means.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A broom cleaning apparatus for a concrete finishing broom, the apparatus comprising:
a trough defining a reservoir in the trough for containing a fluid, the trough having a rim defining an opening to the reservoir at a top side of the trough, the opening being elongated, the opening having a size such that the opening is configured for receiving a brush of the concrete finishing broom; and
a wiper being coupled to the rim of the trough, the wiper having a planar cross-sectional shape being angled relative to the rim such that the wiper extends simultaneously inwardly and upwardly with respect to the rim.

2. The apparatus of claim 1, further comprising a base being coupled to a bottom side of the trough, said base having a planar bottom such that the base is configured for being positioned on a planar support surface.

3. The apparatus of claim 1, wherein an interior surface of the trough is continuously arcuate and extending around a longitudinal axis of the reservoir.

4. The apparatus of claim 1, wherein a thickness of the trough between an interior surface of the trough and an exterior surface of the trough tapers from a bottom side of the trough to the rim.

5. The apparatus of claim 1, wherein the wiper comprises a resiliently bendable material such that the wiper is configured to bend when the brush of the concrete finishing broom is urged against the wiper while moving through the opening of the reservoir.

6. The apparatus of claim 5, wherein the resiliently bendable material comprises rubber.

7. The apparatus of claim 1, wherein the wiper extends along an entirety of the rim.

8. The apparatus of claim 1, wherein an outer surface of the wiper is flush with an exterior surface of the trough.

9. The apparatus of claim 1, wherein an inner surface of the wiper is inset from the rim of the trough.

10. A broom cleaning apparatus for a concrete finishing broom, the apparatus comprising:
a base having a planar bottom such that the base is configured for being positioned on a planar support surface;
a trough being mounted on the base, the trough defining a reservoir in the trough for containing a fluid, the trough having a rim defining an opening to the reservoir at a top side of the trough, the opening being elongated, the opening having a size such that the opening is configured for receiving a brush of a concrete finishing broom, an interior surface of the trough being continuously arcuate and extending around a longitudinal axis of the reservoir, a thickness of the trough between the interior surface and an exterior surface of the trough tapering from a bottom side of the trough to the rim; and
a wiper being coupled to the rim of the trough, the wiper having a planar cross-sectional shape being angled relative to the rim such that the wiper extends simultaneously inwardly and upwardly with respect to the rim, the wiper comprising a resiliently bendable material such that the wiper is configured to bend when the brush of the concrete finishing broom is urged against the wiper while moving through the opening of the reservoir, the resiliently bendable material comprising rubber, the wiper extending along an entirety of the rim, an outer surface of the wiper being flush with the exterior surface of the trough, an inner surface of the wiper being inset from the rim of the trough.

11. (canceled)

12. (canceled)

13. (canceled)

14. (canceled)
